(19) United States
(12) Patent Application Publication
(10) Pub. No.: US 2013/0120671 A1
(43) Pub. Date: May 16, 2013

(54) LIQUID CRYSTAL DISPLAY PANEL AND LIQUID CRYSTAL PROJECTOR

(71) Applicant: SONY CORPORATION, Tokyo (JP)

(72) Inventors: Yasuhiro Shirasaka, Kanagawa (JP); Masahiko Oda, Kumamoto (JP); Hideshi Nakamura, Kumamoto (JP)

(73) Assignee: SONY CORPORATION, Tokyo (JP)

(21) Appl. No.: 13/667,754

(22) Filed: Nov. 2, 2012

(30) Foreign Application Priority Data
Nov. 16, 2011 (JP) 2011-250380

(51) Int. Cl. G02F 1/1335; G02F 1/1343

(52) U.S. Cl. 349/5; 349/139

(57) ABSTRACT

Disclosed herein is a liquid crystal display panel wherein: dummy pixels are created at locations surrounding an effective pixel area; and if the dummy pixels include same-column dummy pixels provided on the same pixel column as pixels provided in the effective pixel area, at least, a pixel transistor employed in each of the same-column dummy pixels is electrically disconnected from a signal line.

### CROSS REFERENCES TO RELATED APPLICATIONS

The present application claims priority to Japanese Priority Patent Application JP 2011-250380 filed in the Japan Patent Office on Nov. 16, 2011, the entire content of which is hereby incorporated by reference.

### BACKGROUND

The present application relates to a liquid crystal display panel and a liquid crystal projector configured to include the liquid crystal display panel. For more information, refer to Japanese Patent Laid-open No. 2010-85882.

As an apparatus for displaying an image based on an image signal, there is widely used a liquid crystal projector for projecting an image on a projection target such as a screen.

FIG. 13 is a circuit diagram showing a simplified configuration of a liquid crystal display panel 100 employed in a liquid crystal projector.

As shown in the figure, the liquid crystal display panel 100 includes a plurality of signal lines Ld stretched in the vertical direction and a plurality of scanning lines Lg stretched in the horizontal direction. The signal line Ld and the scanning line Lg are also referred to as a data line and a gate line respectively. At each intersection of the signal lines Ld and the scanning lines Lg, a pixel G is created.

It is to be noted that, in order to make the following explanation simple, the figure shows only two signal lines Ld and two scanning lines Lg. The two signal lines Ld are signal lines Ld-1 and Ld-2 whereas the two scanning lines Lg are scanning lines Lg-1 and Lg-2. The figure also shows only four pixels G-11, G-12, G-21 and G-22 created at respectively four intersections of the signal lines Ld-1 and Ld-2 as well as the scanning lines Lg-1 and Lg-2. To be more specific, the pixel G-11 is a pixel G created at the intersection of the signal line Ld-1 and the scanning line Lg-1 whereas the pixel G-12 is a pixel G created at the intersection of the signal line Ld-2 and the scanning line Lg-1. By the same token, the pixel G-21 is a pixel G created at the intersection of the signal line Ld-1 and the scanning line Lg-2 whereas the pixel G-22 is a pixel G created at the intersection of the signal line Ld-2 and the scanning line Lg-2.

Each pixel G is configured to include a pixel transistor Tr which is typically a TFT (Thin Film Transistor), a liquid crystal cell LC and a charge holding capacitor C.

The gate electrode of the pixel transistor Tr is connected to a scanning line Lg whereas the source electrode of the pixel transistor Tr is connected to a signal line Ld. The gate electrode is used as the control terminal of the pixel transistor Tr whereas the source electrode is used as the input terminal of the pixel transistor Tr.

The pixel electrode of the liquid crystal cell LC is connected to the drain electrode of the pixel transistor Tr whereas the opposite electrode of the liquid crystal cell LC is connected to a Vcom line. The drain electrode of the pixel transistor Tr is used as the output terminal of the pixel transistor Tr.

In addition, a specific electrode of the charge holding capacitor C is connected to the drain electrode of the pixel transistor Tr whereas the other electrode of the charge holding capacitor C is connected to the Vcom line.

In the liquid crystal display panel 100 having the configuration described above, when a signal is asserted on a scanning line Lg, all pixels G connected to the scanning line Lg are selected. That is to say, when a signal is asserted on a scanning line Lg, all pixels G created on a row associated with the scanning line Lg are selected. A pixel G selected in this way receives a voltage appearing on a signal line Ld connected to the pixel G so that pixel values are each written into one of the pixels G created on the row.

As described above, a row is selected by the scanning line Lg associated with the row in order to write pixel values into the pixels G on the row through the signal lines Ld in a row operation. This row operation is carried out sequentially on a row-after-another basis in order to allow a required image to be displayed on the liquid crystal display panel 100.

FIG. 14 is a diagram showing a simplified configuration of an optical system employed in a liquid crystal projector.

First of all, a light beam Li shown in the figure is an incident light beam radiated by a light source not shown in the figure. The light beam Li is incident to a polarization plate 101 provided on the front side of a liquid crystal display panel 100 employed in the liquid crystal projector. The front side is also referred to as the light-source side.

The polarization plate 101 selectively transmits a predetermined linear polarization component included in the light beam Li and lets this component arrive at the liquid crystal display panel 100.

A light beam Li passing through a pixel G on the liquid crystal display panel 100 is incident to a polarization plate 102.

The polarization plate 102 selectively transmits a predetermined linear polarization component included in the light beam Li passing through the liquid crystal display panel 100 and lets this component arrive at a prism 103 or the like.

The prism 103 directs the light beam Li transmitted by the polarization plate 102 to a projection optical system.

FIGS. 15A and 15B are explanatory diagrams referred to in the following description of polarization control implemented by making use of the liquid crystal display panel 100, the polarization plate 101 and the polarization plate 102. The polarization control is control of black and white displays.

To be more specific, FIG. 15A shows a state at a liquid crystal modulation time or a white display time whereas FIG. 15B shows a state at a no-liquid crystal modulation time or a black display time.

First of all, as described above, the polarization plate 101 provided on the front side of the liquid crystal display panel 100 selectively transmits a predetermined linear polarization component included in the light beam Li incident from the light source side.

At the liquid crystal modulation time shown in FIG. 15A, a pixel G on the liquid crystal display panel 100 modulates the polarization direction of the light beam Li transmitted by the polarization plate 101 as described above. To put it concretely, in this case, the polarization direction of the light beam Li transmitted by the liquid crystal display panel 100 is modulated in a direction perpendicular to the polarization direction of the light beam Li transmitted by the polarization plate 101.

The polarization plate 102 is configured to selectively transmit the light beam Li in accordance with such a post-modulation polarization state set by the liquid crystal display panel 100. As a result, at the liquid crystal modulation time shown in FIG. 15A, the light beam Li is directed to the projection optical system to implement a white display or a turned-on state.

At the no-liquid crystal modulation time shown in FIG. 15B, on the other hand, a pixel G on the liquid crystal display panel 100 does not modulate the polarization direction of the light beam Li transmitted by the polarization plate 101. Thus, the light beam Li passing through the liquid crystal display panel 100 is not transmitted by the polarization plate 102 and not directed to the projection optical system. As a result, a black display or a turned-off state is implemented.

In recent years, the luminance of the liquid crystal projector is increased whereas the size of the projector is decreased. Thus, the density of light in the optical system is being raised at a very high pace.

In the past, polarization plates made of typically an organic material were used as the polarization plates 101 and 102 employed in the optical system. In such an optical system, absorption of light and polarization control were implemented.

The polarization control is control to turn on and off If the density of light in the optical system is increased, however, there is raised a problem in the light resistance characteristic of the polarization plate made of an organic material. Thus, it is feared that the quality of the displayed image is worsened due to deteriorations of the performance.

In order to solve the problem, polarization plates made of typically an inorganic material such as wire grids are used as the polarization plates 101 and 102 in order to improve the light resistance characteristic.

If the polarization plates 101 and 102 made of such an inorganic material are used, the control is carried out on light reflection instead of light absorption. That is to say, at a black display time like the one shown in FIG. 15B, the light beam Li transmitted by the liquid crystal display panel 100 is not absorbed by the polarization plate 102 but reflected back to the liquid crystal display panel 100 to implement a turned-off state.

By the way, the liquid crystal display panel 100 includes an effective pixel area 100a and a dummy pixel area 100b surrounding the effective pixel area 100a. The effective pixel area 100a is an area used for displaying a valid image which is an image to be actually projected on a screen or the like.

FIG. 16A is a top-view diagram showing a relation between the effective pixel area 100a and the dummy pixel area 100b which are created in the liquid crystal display panel 100.

The dummy pixel area 100b is an area not contributing to image displays.

Thus, in order to eliminate image-quality deteriorations caused by the effect of light transmitted by the dummy pixel area 100b on light transmitted by the effective pixel area 100a, the dummy pixel area 100b is provided with a light blocking layer 104 as shown in a cross-sectional diagram of FIG. 16B.

By providing the dummy pixel area 100b with the light blocking layer 104, light transmitted by a dummy pixel in the dummy pixel area 100b is not directed to a later stage of the liquid crystal display panel 100 so that it is possible to prevent the light transmitted by the dummy pixel from being inadvertently mixed with the light transmitted by the effective pixel area 100a.

Under the above assumption, the following description explains the structure of a dummy pixel employed in the dummy pixel area 100b included in the liquid crystal display panel 100 of related art by referring to FIG. 17. In the following description, the dummy pixel is denoted by reference notation G-d′ in the figure.

As shown in FIG. 17, components created in the dummy pixel G-d′ in the liquid crystal display panel 100 of related art include an opposite substrate 30, a transparent electrode 31, a liquid crystal layer 32, a transparent electrode 33, a first light blocking layer 34, a signal line Ld, a contact section Ct, a first semiconductor layer 35 and a scanning line Lg.

Let the surface on a side on which the opposite substrate 30 is created be taken as the light incidence surface hit by a light beam Li coming from the polarization plate 101 whereas the surface on a side on which the scanning line Lg is created be taken as the light exit surface left by the light beam Li. In this case, the created components listed above are provided between the light incidence surface and the light exit surface in the order in which the components are enumerated in the above sentence.

The first light blocking layer 34 which is one of the created components enumerated above corresponds to the light blocking layer 104 shown in FIG. 16B and is provided for shielding the dummy pixel G-d′ against light.

The first semiconductor layer 35 serves as a semiconductor layer in which the pixel transistor Tr described above is created.

The contact section Ct is a member for electrically connecting the signal line Ld to the pixel transistor Tr created in the first semiconductor layer 35.

In addition, in this case, the scanning line Lg can be used also as a second light blocking layer for preventing a light beam Ls reflected by the polarization plate 102 made of an inorganic material from being inevitably radiated directly to the pixel transistor Tr created in the first semiconductor layer 35. To put it concretely, the scanning line Lg in this configuration reflects the reflected light beam Ls, preventing the pixel transistor Tr from being exposed directly to the reflected light beam Ls.

It is to be noted that the second light blocking layer can of course be created separately from the scanning line.

In this case, the pixel transistor Tr is prevented from being exposed directly to the reflected light beam Ls in order to prevent the pixel transistor Tr from deteriorating with the lapse of time due to the direct exposure of the pixel transistor Tr to the reflected light beam Ls. As is generally known, the deterioration of the pixel transistor Tr undesirably worsens the quality of the displayed image.

### SUMMARY

As described above, by providing the second light blocking layer shown as the scanning line Lg in FIG. 17 in the dummy pixel G-d′ of related art, it is possible to prevent the pixel transistor Tr from being exposed directly to the reflected light beam Ls coming from the polarization plate 102.

By merely providing such a second light blocking layer only, however, it has been confirmed that the high density of light in the optical system described above has a bad effect on the performance so that the quality of the displayed image undesirably worsens.

In order to solve this problem, that is, in order to prevent the quality of the displayed image from worsening due to the light beam Ls reflected by the polarization plate 102, instead of creating the second light blocking layer in only a portion corresponding to an area in which the pixel transistor Tr or the first semiconductor layer 35 is created as is the case with a configuration shown in FIG. 17, there is adopted a conceivable countermeasure of creating the second light blocking layer on the entire surface of the dummy pixel G-d′.

However, this countermeasure entails an additional process of creating a new light blocking layer, that is, the second light blocking layer. Unfortunately, the process reduces the producibility of the liquid crystal display panel 100 and, thus, raises the cost of the liquid crystal display panel 100.

In addition, if the second light blocking layer is created on the entire surface of the dummy pixel G-d′, the amount of generated stray light adversely increases so that it is feared that the quality of the displayed image inevitably worsens.

It is thus desired for the present application addressing the existing problems to prevent the quality of the displayed image from worsening due to incident light from the panel exit surface side to the dummy pixel of related art without raising other problems such as decreased producibility and an increased cost which would be otherwise caused by a newly introduced additional process like the one described above.

In order to solve the existing problems, the liquid crystal display panel according to an embodiment of the present application is provided with a proposed configuration described as follows.

In the liquid crystal display panel according to the embodiment of the present application, dummy pixels are created at locations surrounding the effective pixel area.

The dummy pixels include specific dummy pixels provided on the same pixel columns as the pixels provided in the effective pixel area. The specific dummy pixel is referred to as a same-column dummy pixel. At least, the pixel transistor employed in the same-column dummy pixel is electrically disconnected from the signal line shared by pixels on the same column in the effective pixel area as the dummy pixel.

In addition, the liquid crystal projector according to another embodiment of the present application is provided with a proposed configuration described as follows.

The liquid crystal projector according to the embodiment of the present application is provided with a light source and a liquid crystal display panel for optically modulating light emitted by the light source in pixel units. In this configuration, the liquid crystal display panel employed in the liquid crystal projector is the liquid crystal display panel according to the above embodiment of the present application.

The so-called V-T characteristic of a pixel is a characteristic representing a relation between an electric potential appearing on a signal line connected to the pixel transistor of the pixel and the transmittance of the pixel. The V-T characteristic changes because a leak current flows from the drain electrode of the pixel transistor in the pixel to the source electrode of the pixel transistor, resulting in a change of the electric potential appearing on the signal line connected to the pixel transistor. Such a leak current flows in a dummy pixel due to the deterioration of the performance of the pixel transistor in the dummy pixel, resulting in a change of the electric potential of the signal line which is also connected to the pixel transistor of a pixel in the effective pixel area. The change of the electric potential of the signal line causes a change of the V-T characteristic of the pixel in the effective pixel area. As will be described later, the problem of image-quality deteriorations caused by performance degradations due to radiation of light to the pixel transistor in the dummy pixel is conceivably attributed to the inevitable change of the V-T characteristic of a pixel in the effective pixel area.

In order to solve the problem described above, in accordance with the present application, the pixel transistor employed in the dummy pixel is electrically disconnected from the signal line as explained earlier.

Thus, since the change of the V-T characteristic of a pixel in the effective pixel area is caused by the deterioration of the performance of the pixel transistor in the dummy pixel as described above, by electrically disconnecting the pixel transistor employed in the dummy pixel from the signal line, it is possible to effectively get rid of the change. As a result, the quality of the displayed image can be prevented from worsening.

In addition, in electrically disconnecting the pixel transistor employed in the dummy pixel from the signal line as described above, it is possible to easily adopt a technique not entailing an additional process such as a process of eliminating a contact section for connecting the pixel transistor to the signal line. The technique also does not require another process such as a process of creating a new layer separately.

That is to say, in accordance with the embodiments of the present application, it is possible to avoid deteriorations of the image quality without raising, among others, the problem of adding a new process and the problem of a rising cost.

As described above, in accordance with the present application, it is possible to prevent the quality of the displayed image from worsening due to light incident to a dummy pixel from the light exit surface of the liquid crystal display panel without raising, among others, the producibility problem and the rising-cost problem which would be otherwise caused by the need for an additional process.

Additional features and advantages are described herein, and will be apparent from the following Detailed Description and the figures.

### BRIEF DESCRIPTION OF THE FIGURES

FIG. 1 is an explanatory diagram to be referred to in description of the internal configuration of a liquid crystal projector according to an embodiment;

FIG. 2 is an explanatory diagram to be referred to in description of the internal configuration of a liquid crystal display panel according to an embodiment;

FIG. 3 is a diagram showing a simplified configuration of the dummy pixel of related art;

FIG. 4 is a diagram to be referred to in consideration of a rationale according to which the quality of the image deteriorates due to radiation of light to a pixel transistor;

FIGS. 5A and 5B are explanatory diagrams to be referred to in description of the configuration of a dummy pixel according to a first embodiment;

FIG. 6 is a diagram showing a cross-sectional structure of the dummy structure of related art;

FIG. 7 is a diagram showing a cross-sectional structure of the dummy structure according to the first embodiment;

FIG. 8 is a diagram showing experimental results representing relations between the time of light radiation to the pixel transistor of the dummy pixel and the variation of luminance of a pixel in an effective pixel area;

FIG. 9 is a diagram showing experimental results representing relations between the aging time and the chromaticity change of a displayed image;

FIGS. 10A and 10B are explanatory diagrams to be referred to in description of the configuration of a dummy pixel according to a second embodiment;

FIG. 11 is a diagram showing a cross-sectional structure of the dummy structure according to the second embodiment;

FIG. 12 is a diagram showing the top view of a pixel creation area in a liquid crystal display panel;

FIG. 13 is a circuit diagram showing a simplified configuration of a liquid crystal display panel employed in a liquid crystal projector;

FIG. 14 is a diagram showing a simplified configuration of an optical system employed in a liquid crystal projector;

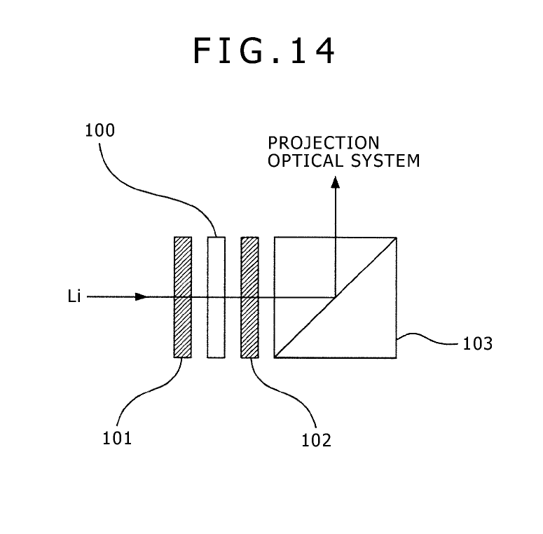

FIGS. 15A and 15B are explanatory diagrams to be referred to in description of polarization control implemented by making use of a liquid crystal display panel and polarization plates as control of white and black displays;

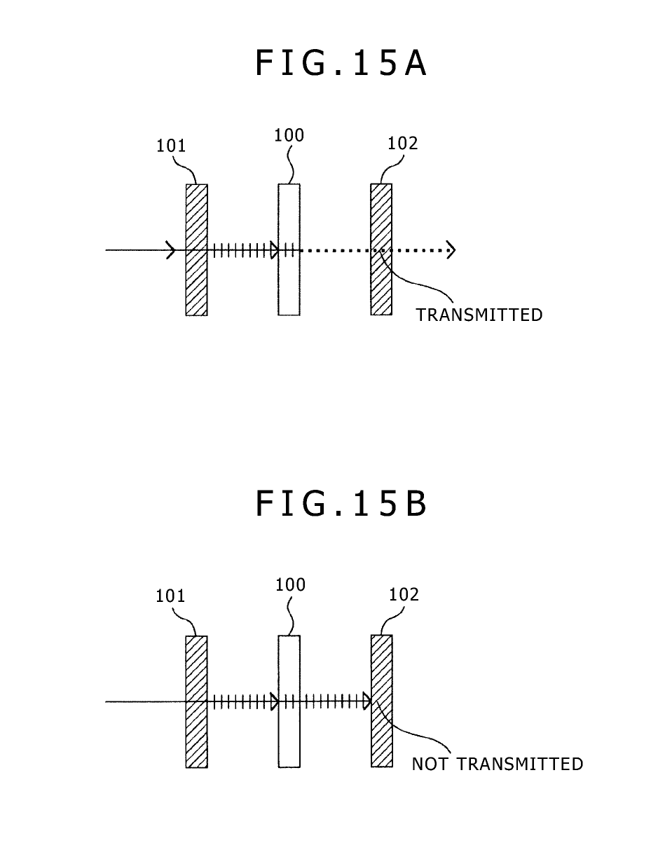

FIGS. 16A and 16B are explanatory diagrams to be referred to in description of a light blocking layer created in a dummy pixel of a dummy pixel area; and

FIG. 17 is an explanatory diagram showing the structure of a dummy pixel employed in the liquid crystal display panel of related art.

### DETAILED DESCRIPTION

Embodiments of the present application are described below. It is to be noted that the following description is divided into topics arranged as follows.

### 1. Configuration of the Liquid Crystal Projector

### 2. Configuration of the Liquid Crystal Display Panel

### 3. Configuration of the Dummy Pixel According to a First Embodiment

### 4. Configuration of the Dummy Pixel According to a Second Embodiment

### 5. Typical Modifications

<1. Configuration of the Liquid Crystal Projector>

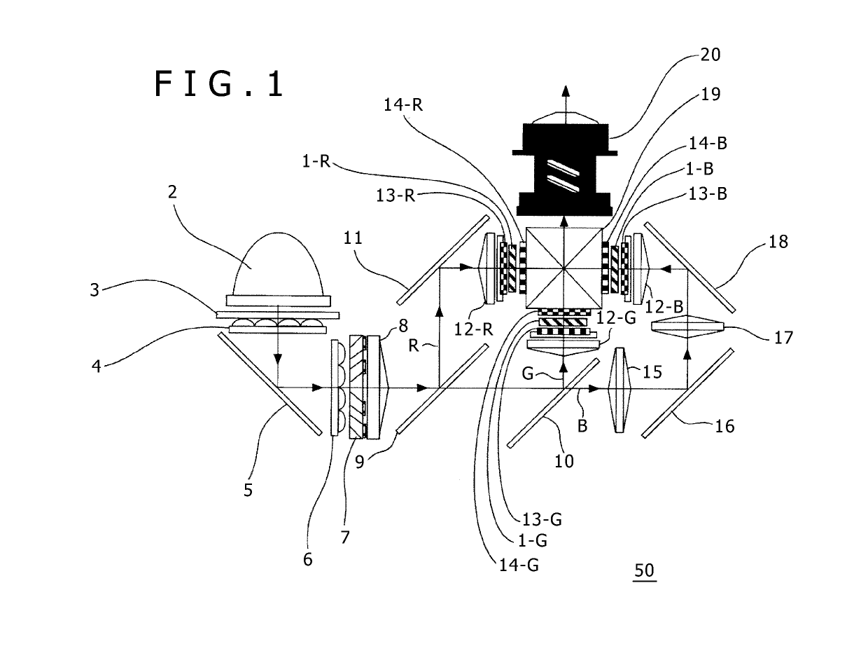

FIG. 1 is an explanatory diagram referred to in the following description of the internal configuration of a liquid crystal projector 50 according to an embodiment of the present application.

It is to be noted that FIG. 1 mainly shows only the configuration of the optical system employed in the liquid crystal projector 50. That is to say, the configurations of other portions are not shown in the figure.

The liquid crystal projector 50 according to the embodiment is a projection-type liquid crystal display apparatus adopting the so-called three-plate system for displaying a color image by making use of three plates, that is, liquid crystal display panels 1-R, 1-G and 1-B for the red, green and blue colors respectively. The liquid crystal projector 50 makes use of the liquid crystal display panels 1-R, 1-G and 1-B as liquid crystal display panels 1 of a transmission type.

As shown in the figure, the liquid crystal projector 50 includes a light source 2, a UV/IR cut filter 3, a first lens array 4, a mirror 5 and a second lens array 6. The UV/IR cut filter 3 is also referred to as an ultraviolet-light/infrared-light cut filter. The first lens array 4 and the second lens array 6 which are fly-eye lenses form a pair of lens arrays.

The light source 2 emits white-color light including red-color light, green-color light and blue-color light which are required in a display of a color image. The light source 2 is configured to include a light emitting body not shown in the figure and a concave mirror. The light emitting body emits the white-color light whereas the concave mirror reflects the white-color light emitted by the light emitting body. The light emitting body can be typically a halogen lamp, a metal halide lamp or a xenon lamp. The concave mirror is designed to have a rotary symmetrical surface shape such as the shape of a rotary elliptical surface mirror or the shape of a rotary parabolic surface mirror.

The UV/IR cut filter 3 cuts ultraviolet rays and infrared rays from the white-color light emitted by the light source 2 in order to prevent a variety of optical components provided at later stages from being overheated and from deteriorating.

In addition, the mirror 5 is provided between the first lens array 4 and the second lens array 6 in a posture bending the optical path (or the optical axis) toward the second lens array 6 by an angle of about 90 degrees.

The first lens array 4 and the second lens array 6 each include a plurality of micro-lenses laid out two-dimensionally to form a matrix. The first lens array 4 and the second lens array 6 each make illumination intensity distributions of light uniform. The first lens array 4 and the second lens array 6 each have a function for dividing incident light into a plurality of thin light fluxes. Thus, when the white-color light emitted by the light source 2 passes through the first lens array 4 and the second lens array 6, the light is divided into a plurality of thin light fluxes.

On the light exit surface side of the second lens array 6, a PS synthesis device 7, a condenser lens 8 and a dichroic mirror 9 are provided in the same order as enumerated.

On the PS synthesis device 7, a plurality of 1/2-wavelength plates are provided at positions corresponding to locations between adjacent micro-lenses in the second lens array 6. The PS synthesis device 7 separates incident light coming from the second lens array 6 into first polarized light such as the P polarization component and second polarized light such as the S polarization component. Specific polarized light such as the P polarization component is emitted from the PS synthesis device 7 by sustaining the polarization direction of the specific polarized light as it is. An effect of the 1/2-wavelength plate converts the other polarized light such as the S polarization component into the specific polarized light such as the P polarization component and emits the specific polarized light such as the P polarization component obtained as a result of the conversion from the PS synthesis device 7. Thus, the polarization directions of the specific polarized light and the other polarized light are made uniform in a particular direction. In the example described above, the particular direction is the polarization direction of the P polarization component.

The light emitted by the PS synthesis device 7 propagates to the dichroic mirror 9 by way of the condenser lens 8. The dichroic mirror 9 separates the light incident thereto into red-color light R and light of other colors.

As shown in the figure, a mirror 11, a field lens 12-R, a polarization plate 13-R, a liquid crystal display panel 1-R and a polarization plate 14-R are provided along the optical path of the red-color light R separated by the dichroic mirror 9 in the same order as enumerated.

The mirror 11 reflects the red-color light R separated by the dichroic mirror 9 to the liquid crystal display panel 1-R. The red-color light R reflected by the mirror 11 propagates to the liquid crystal display panel 1-R by way of the field lens 12-R and the polarization plate 13-R. The red-color light R incident to the liquid crystal display panel 1-R is subjected to a spatial modulation process according to an image signal in the liquid crystal display panel 1-R. Then, light obtained as a result of the spatial modulation process propagates to a cross prism 19 by way of the polarization plate 14-R.

In the case of this embodiment, polarization plates made of an inorganic material such as wire grids are used as the polarization plates 13 and 14. Such an inorganic material secures a characteristic of resistance against a high light density in the optical system.

The other-color light than the red-color light R separated by the dichroic mirror 9 propagates to a dichroic mirror 10. The dichroic mirror 10 separates the light incident thereto into green-color light G and blue-color light B.

As shown in the figure, a field lens 12-G, a polarization plate 13-G, a liquid crystal display panel 1-G and a polarization plate 14-G are provided along the optical path of the green-color light G separated by the dichroic mirror 10 in the same order as enumerated.

The green-color light G propagates to the liquid crystal display panel 1-G by way of the field lens 12-G and the polarization plate 13-G. The green-color light G incident to the liquid crystal display panel 1-G is subjected to a spatial modulation process according to an image signal in the liquid crystal display panel 1-G. Then, light obtained as a result of the spatial modulation process propagates to the cross prism 19 by way of the polarization plate 14-G.

In addition, as shown in the figure, a relay lens 15, a mirror 16, a relay lens 17, a mirror 18, a field lens 12-B, a polarization plate 13-B, a liquid crystal display panel 1-B and a polarization plate 14-B are provided along the optical path of the blue-color light B separated by the dichroic mirror 10 in the same order as enumerated.

The mirror 16 reflects the incident blue-color light B coming from the relay lens 15 to the mirror 18. The mirror 18 reflects the incident blue-color light B reflected by the mirror 16 and directed to propagate to the mirror 18 by way of the relay lens 17 to the liquid crystal display panel 1-B.

The blue-color light B reflected by the mirror 18 propagates to the liquid crystal display panel 1-B by way of the field lens 12-B and the polarization plate 13-B. The blue-color light B incident to the liquid crystal display panel 1-B is subjected to a spatial modulation process according to an image signal in the liquid crystal display panel 1-B. Then, light obtained as a result of the spatial modulation process propagates to the cross prism 19 by way of the polarization plate 14-B.

The cross prism 19 is provided at a position at which the optical paths of the red-color light R, the green-color light G and the blue-color light B intersect with each other. The cross prism 19 combines the red-color light R, the green-color light G and the blue-color light B in a synthesis process.

Synthesized light emitted by the cross prism 19 is directed to a projection optical system 20. The projection optical system 20 projects the synthesized light to a projection target such as a screen. The projection target is provided at typically a location external to the liquid crystal projector 50. Thus, an image according to the modulation processes carried out by the liquid crystal display panel 1 is projected (or displayed) on the projection target such as a screen.

It is to be noted that, as shown in none of the figures, the liquid crystal projector 50 is provided with sections including a signal processing circuit for driving the liquid crystal display panels 1-R, 1-G and 1-B in accordance with input image signals.

<2. Configuration of the Liquid Crystal Display Panel>

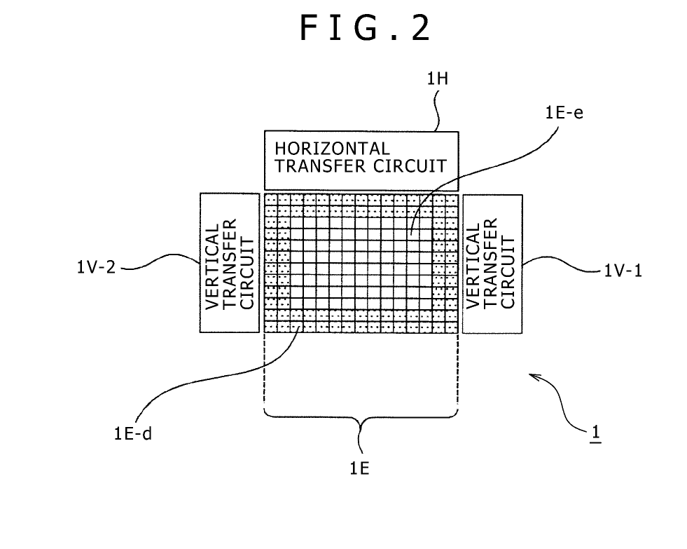

FIG. 2 is an explanatory diagram referred to in the following description of the internal configuration of a liquid crystal display panel 1 employed in the liquid crystal projector 50 shown in FIG. 1.

As shown in the figure, in the liquid crystal display panel 1, a pixel creation area 1E, a horizontal transfer circuit 1H, a vertical transfer circuit 1V-1 and a vertical transfer circuit 1V-2 are created. The pixel creation area 1E is an area in which a plurality of pixels G are created.

As shown in none of the figures including FIG. 2, in the pixel creation area 1E, a scanning line Lg also referred to as a gate line is connected to a plurality of pixels G laid out in a row direction or the horizontal direction on the diagram page for a row to serve as a line common to the pixels G. In addition, a signal line Ld also referred to as a data line is connected to a plurality of pixels G laid out in a column direction or the vertical direction on the diagram page for a column to serve as a line common to the pixels G. The number of scanning lines Lg is nh denoting the number of rows whereas the number of signal lines Ld is nv denoting the number of columns. On each of the rows, a plurality of pixels G are laid out in the row direction. The number of pixels G laid out in the row direction for a row is nv. By the same token, on each of the columns, a plurality of pixels G are laid out in the column direction. The number of pixels G laid out in the column direction for a column is nh.

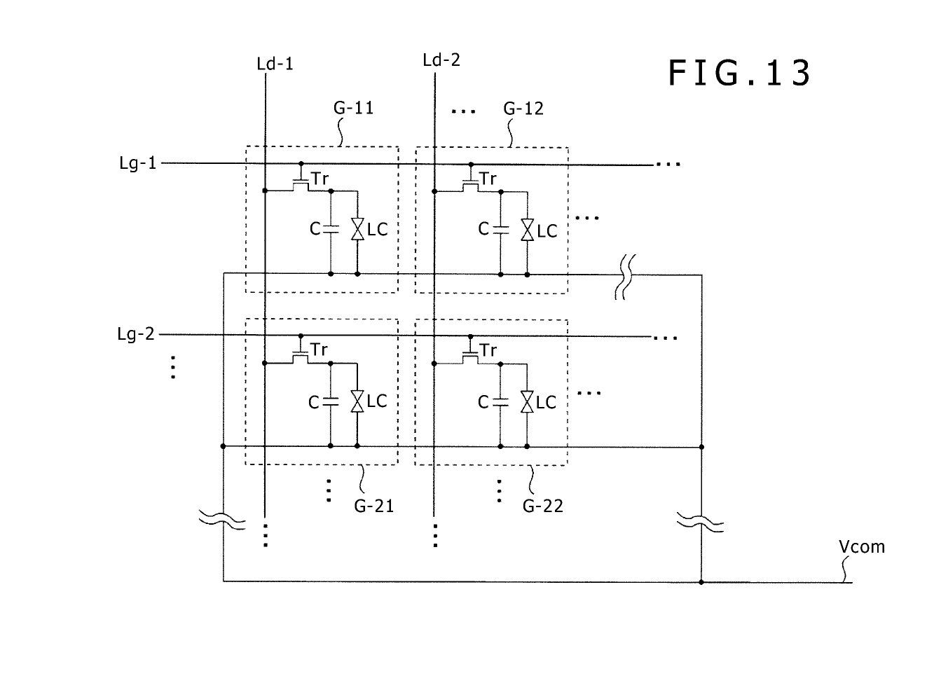

At each intersection of the signal lines Ld and the scanning lines Lg, a pixel G is created. Each pixel G is configured to include a pixel transistor Tr, a liquid crystal cell LC and a charge holding capacitor C as shown in FIG. 13.

The horizontal transfer circuit 1H is a circuit for driving the scanning lines Lg. On the other hand, the vertical transfer circuits 1V-1 and 1V-2 are each a circuit for driving the signal lines Ld.

The pixel creation area 1E in the liquid crystal display panel 1 includes an effective pixel area 1E-e and a dummy pixel area 1E-d surrounding the effective pixel area 1E-e.

The effective pixel area 1E-e is an image display area. Light originating from the light source 2 and passing through pixels created in the effective pixel area 1E-e is projected onto a projection target such as a screen in order to display an image on the projection target.

On the other hand, the dummy pixel area 1E-d is an area not contributing to the display of an image on the projection target.

In the following description, each pixel G created in the dummy pixel area 1E-d is denoted by reference notation G-d.

The following description explains the purpose of providing the dummy pixel area 1E-d surrounding the effective pixel area 1E-e in the liquid crystal display panel 1.

As shown in FIG. 2, the liquid crystal display panel 1 has the pixel creation area 1E and the peripheral circuit which includes the horizontal transfer circuit 1H and the vertical transfer circuits 1V. Boundaries between the pixel creation area 1E and the peripheral circuit exist on the surface of the wafer. In addition, since the film configuration (or the layer structure) of the pixel creation area 1E is different from the film configuration (or the layer structure) of the peripheral circuit, there are protrusion differences on the boundaries. In order to eliminate the protrusion differences from the boundaries, application of a application such as the CMP (Chemical Mechanical Polishing) application to the surface of the wafer is conceivable. Nevertheless, it is very difficult to completely eliminate such protrusion differences from the boundaries.

At a portion with a discontinuous shape of the wafer surface, the thickness of the orientation film of the pixel and the thickness of a spacer for controlling a gap between cells are also not uniform so that there is a bad effect on the orientation direction of the liquid crystal. That is to say, as a result, the quality of the displayed image undesirably deteriorates.

Assume for example that the dummy pixel area 1E-d is not provided at locations surrounding the effective pixel area 1E-e. In this case, the protrusion differences described above are generated on edges of the effective pixel area 1E-e. Thus, the quality of the displayed image also undesirably deteriorates.

Such a displayed image is an image projected on the projection target through the effective pixel area 1E-e. Thus, in order to prevent the quality of the displayed image from deteriorating, the dummy pixel area 1E-d not contributing to the display of the image is provided at locations surrounding the effective pixel area 1E-e. That is to say, a pixel area with protrusion differences such as the ones described above is allocated to the dummy pixel area 1E-d in order to assure the flatness of the effective pixel area 1E-e. Thus, it is possible to prevent the quality of the displayed image from deteriorating.

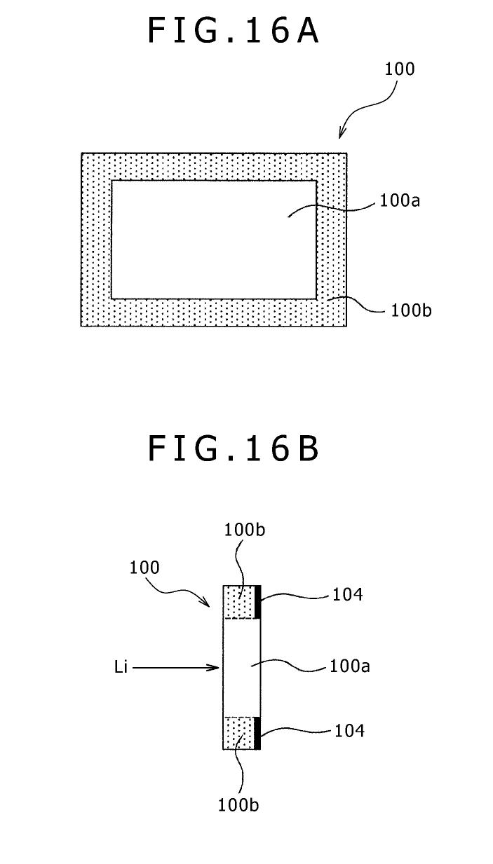

In this case, however, light transmitted by the dummy pixel area 1E-d has a bad effect on light transmitted by the effective pixel area 1E-e so that the quality of the displayed image deteriorates as explained earlier. In order to prevent the quality of the displayed image from deteriorating due to this bad effect, a light blocking layer shown as the light blocking layer 104 in FIG. 16 is provided in the effective pixel area 1E-e.

On top of that, in the process of preventing the quality of the displayed image from deteriorating due to the light transmitted by the dummy pixel area 1E-d, modulation is carried out in some cases in the dummy pixel G-d in order to minimize the transmittance of the dummy pixel G-d in addition to the creation of the light blocking layer described above.

<3. Configuration of the Dummy Pixel According to a First Embodiment>

In the case of the liquid crystal projector of related art explained before, the polarization plates 13 and 14 implemented as polarization plates each made of an inorganic material such as wire grids are provided on respectively the front and rear sides of the liquid crystal display panel 1. That is to say, polarization control based on reflection of light is carried out in place of polarization control based on absorption of light. In the case of the polarization control based on reflection of light, light reflected by the polarization plate 14 to the liquid crystal display panel 1 is inadvertently radiated directly to the pixel transistor Tr employed in the dummy pixel G-d′ of related art on the liquid crystal display panel 1. In order to prevent the light reflected by the polarization plate 14 to the liquid crystal display panel 1 from being inadvertently radiated directly to the pixel transistor Tr, a second light blocking layer is provided.

By merely creating such a second light blocking layer only, however, the high density of light in the optical system described above has a bad effect on the performance so that the quality of the displayed image undesirably worsens.

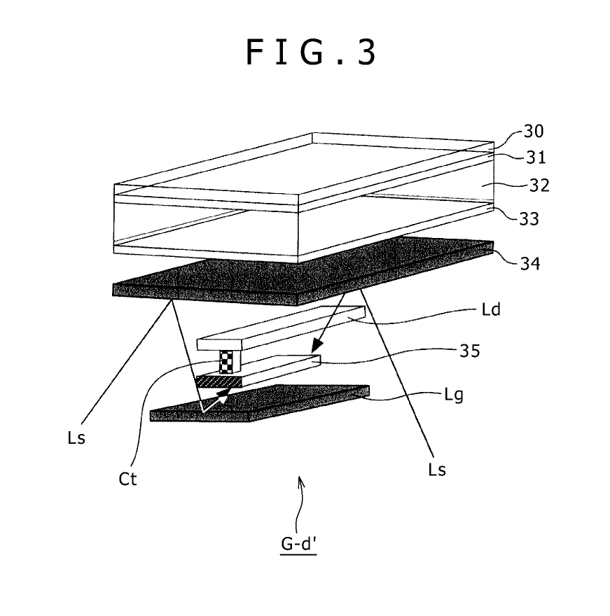

Thus, for confirmation, FIG. 3 is given as a diagram showing a simplified configuration of the dummy pixel G-d′ of related art.

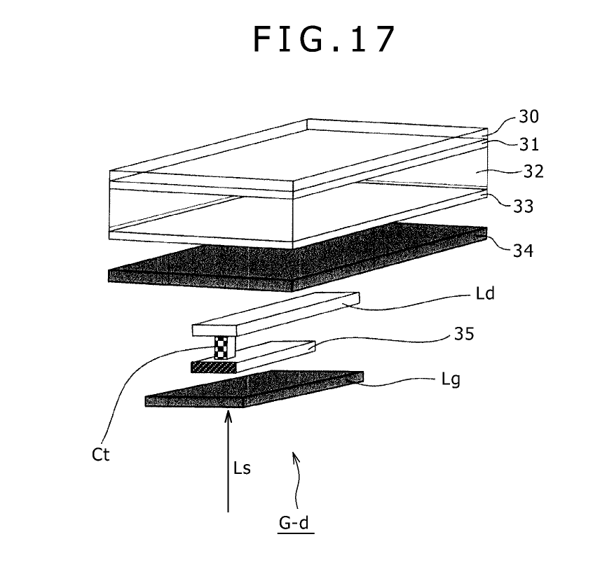

As explained earlier by referring to FIG. 17, the dummy pixel G-d′ of related art includes an opposite substrate 30, a transparent electrode 31, a liquid crystal layer 32, a transparent electrode 33, a first light blocking layer 34, a signal line Ld, a contact section Ct, a first semiconductor layer 35 and a scanning line Lg which are created in the same order as enumerated.

Let the surface on a side on which the opposite substrate 30 is created be taken as the light incidence surface of a light beam Li coming from the polarization plate 13 whereas the surface on a side on which the scanning line Lg is created be taken as the light exit surface of the light beam Li. In this case, the components are created from the light incidence surface to the light exit surface in the same order as enumerated.

The first light blocking layer 34 is provided to serve as a layer for preventing light transmitted by the dummy pixel area 1E-d from affecting light transmitted by the effective pixel area 1E-e so as to avoid deteriorations of the quality of the displayed image. As shown in the figure, the first light blocking layer 34 is created to cover the entire pixel. The first light blocking layer 34 corresponds to the light blocking layer 104 shown in FIG. 16.

The first semiconductor layer 35 is a semiconductor layer in which the pixel transistor Tr is created.

The contact section Ct is a member electrically connecting the signal line Ld to the pixel transistor Tr created in the first semiconductor layer 35.

In this configuration, if a second light blocking layer is created on the entire surface of the dummy pixel G-d′ of related art, light reflected by the second blocking layer becomes stray light. Accordingly, the amount of generated stray light adversely increases so that it is feared that the quality of the displayed image inevitably worsens. In order to prevent the quality of the displayed image from worsening, instead of creating the second light blocking layer on the entire surface of the dummy pixel G-d′ of related art, the second light blocking layer is created on only a portion corresponding to a portion used for creation of the first semiconductor layer 35 in which the pixel transistor Tr is created. It is to be noted that, in this configuration, the scanning line Lg is used also to serve also as the second light blocking layer.

In such a configuration, as shown in the figure, the light beam Ls reflected by the polarization plate 14 provided on the light exit surface of the liquid crystal display panel 1 inevitably propagates to the rear side of the first light blocking layer 34. The first light blocking layer 34 then reflects the light beam Ls and undesirably radiates the light beam Ls to the first semiconductor layer 35 including the pixel transistor Tr.

In addition, since the first light blocking layer 34 reflects the light beam Ls, the light beam Ls is undesirably radiated to the first semiconductor layer 35 also by way of the first light blocking layer 34 and the scanning line Lg serving also as the second light blocking layer.

The effect of the radiation of such a light beam Ls inevitably deteriorates the performance of the pixel transistor Tr.

It has been confirmed that the deterioration of the performance of the pixel transistor Tr worsens the quality of an image displayed on the effective pixel area 1E-e.

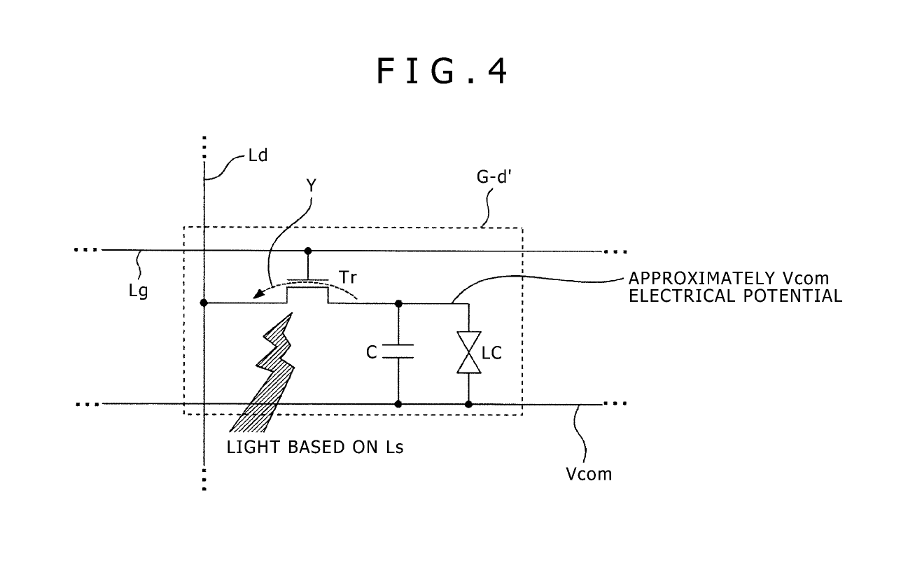

Next, by referring to FIG. 4, the following description explains a rationale according to which the quality of the image deteriorates due to radiation of light to a pixel transistor Tr.

FIG. 4 is a diagram showing the circuit of the dummy pixel G-d′ of related art.

As shown in the figure, the dummy pixel G-d′ of related art is created at an intersection of a scanning line Lg and a signal line Ld and is configured to include a pixel transistor Tr, a liquid crystal cell LC and a charge holding capacitor C.

The pixel transistor Tr is typically a TFT (Thin Film Transistor). The gate electrode of the pixel transistor Tr is connected to the scanning line Lg whereas the source electrode of the pixel transistor Tr is connected to the signal line Ld. The gate electrode is used as the control terminal of the pixel transistor Tr whereas the source electrode is used as the input terminal of the pixel transistor Tr.

The pixel electrode of the liquid crystal cell LC is connected to the drain electrode of the pixel transistor Tr whereas the opposite electrode of the liquid crystal cell LC is connected to a Vcom line which is a common electric-potential supplying line. The drain electrode of the pixel transistor Tr is used as the output terminal of the pixel transistor Tr.

In addition, a specific electrode of the charge holding capacitor C is connected to the drain electrode of the pixel transistor Tr whereas the other electrode of the charge holding capacitor C is connected to the Vcom line.

In this configuration, when the pixel transistor Tr employed in the dummy pixel G-d′ of related art is exposed to relatively strong light, the performance of the pixel transistor Tr deteriorates. In this case, a leak current conceivably flows in a direction indicated by a dashed-line arrow in the figure. That is to say, in the pixel transistor Tr, the leak current conceivably flows from the drain electrode to the source electrode.

The leak current eventually flows to the signal line Ld by way of the contact section Ct explained before by referring to FIG. 3. As a result, the leak current conceivably affects an electric potential appearing on the signal line Ld.

It is needless to say that the electric potential appearing on the signal line Ld represents a signal to be written into the pixel G in the effective pixel area 1E-e. Thus, when the leak current generated in the dummy pixel G-d′ of related art as described above undesirably changes the electric potential appearing on the signal line Ld, the so-called V-T characteristic of the pixel G in the effective pixel area 1E-e also undesirably changes as well. It is inferred that, when the V-T characteristic of the pixel G in the effective pixel area 1E-e changes, the quality of the displayed image inevitably deteriorates. As explained before, the V-T characteristic of a pixel G in the effective pixel area 1E-e is a characteristic representing a relation between an electric potential appearing on a signal line connected to the pixel transistor Tr of the pixel G and the transmittance of the pixel G.

In order to solve the problem described above, in accordance with this embodiment, there has been proposed a configuration in which the pixel transistor Tr employed in the dummy pixel G-d is electrically disconnected from the signal line Ld. By electrically disconnecting the pixel transistor Tr employed in the dummy pixel G-d from the signal line Ld, even if the performance of the dummy pixel G-d deteriorates because the pixel transistor Tr employed in the dummy pixel G-d is exposed to light radiated to the dummy pixel G-d, the deterioration of the performance does not affect an image displayed on the effective pixel area 1E-e through the signal line Ld.

To put it concretely, in the first embodiment, the contact section Ct explained before by referring to FIG. 3 is eliminated in order to electrically disconnect the pixel transistor Tr employed in the dummy pixel G-d from the signal line Ld.

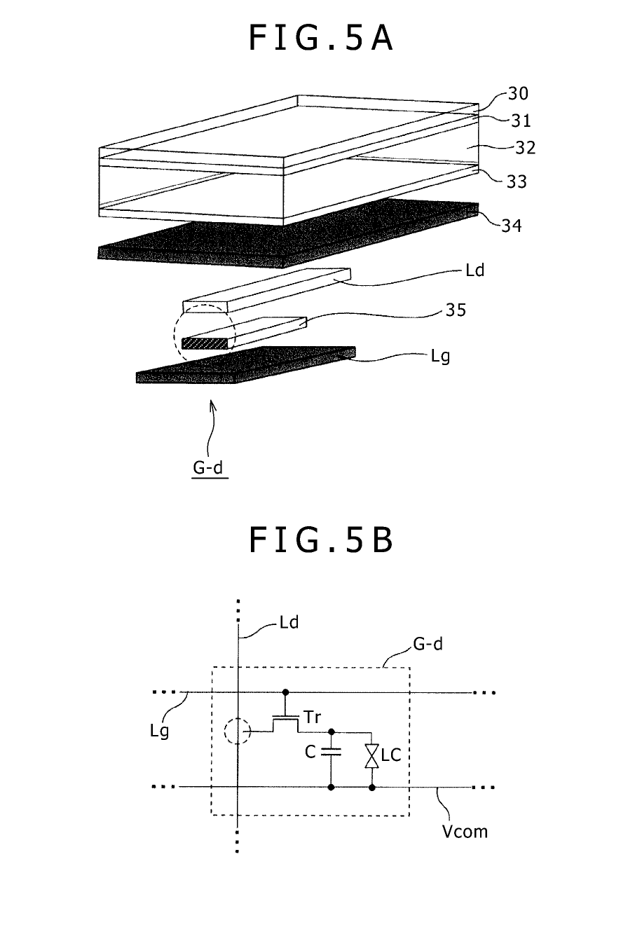

FIGS. 5A and 5B are explanatory diagrams referred to in the following description of the configuration of a dummy pixel G-d created in the liquid crystal display panel 1 according to the first embodiment.

To be more specific, FIG. 5A is a perspective diagram showing a simplified configuration of the dummy pixel G-d whereas FIG. 5B is a diagram showing the circuit of the dummy pixel G-d.

It is to be noted that, in the following description, a member explained before is denoted by the same reference number/notation as that already assigned to the member and the member is not explained again.

By comparing FIG. 5A with FIG. 3, it becomes obvious that the dummy pixel G-d according to the embodiment is different from the dummy pixel G-d′ of related art in that, in the case of the dummy pixel G-d according to the embodiment, the contact section Ct for electrically connecting the first semiconductor layer 35 to the signal line Ld is eliminated. Since the pixel transistor Tr is created in the first semiconductor layer 35, the pixel transistor Tr is electrically disconnected from the signal line Ld.

A dashed-line circle shown in the circuit diagram of FIG. 5B does not include a segment electrically connecting the source electrode of the pixel transistor Tr to the signal line Ld. That is to say, the dashed-line circle shows that the pixel transistor Tr is electrically disconnected from the signal line Ld.

In the following description, the dummy pixel G-d according to the embodiment is compared with the dummy pixel G-d′ of related art in detail.

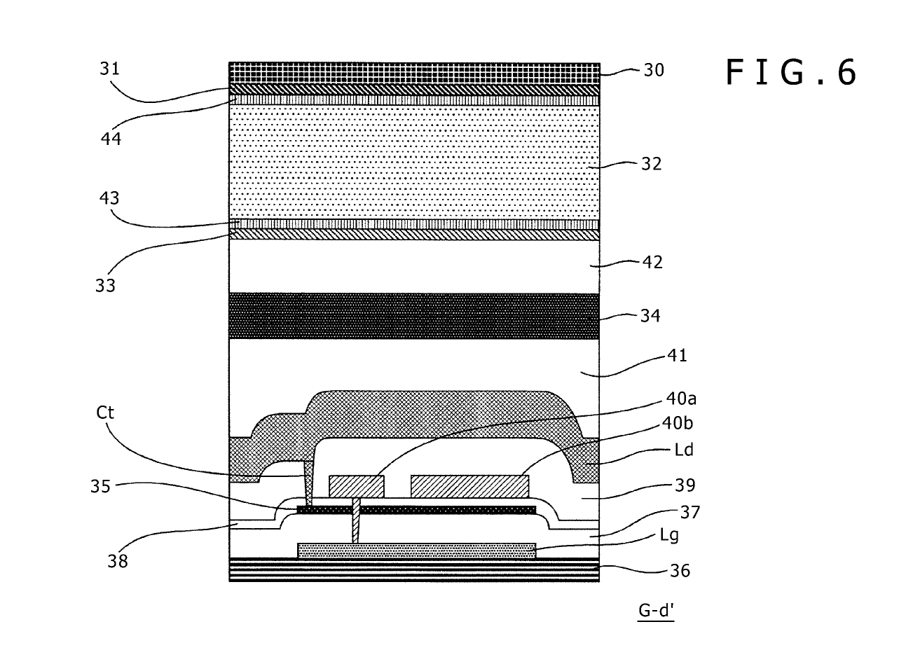

First of all, FIG. 6 is given to serve as a diagram showing a more detailed cross-sectional structure of the dummy pixel G-d′ of related art.

As shown in FIG. 6, in the dummy pixel G-d′ of related art, the scanning line Lg serving also as a second light blocking layer is created above a quartz substrate 36. In addition, on the quartz substrate 36, an insulation film 37 is formed.

After the insulation film 37 has been formed, a first semiconductor layer 35 is created and, after the first semiconductor layer 35 has been created, an oxide film 38 is formed. On the oxide film 38, second semiconductor layers 40a and 40b are created.

In this configuration, the second semiconductor layer 40a is electrically connected to the scanning line Lg and used as the gate electrode of the pixel transistor Tr. In this way, the pixel transistor Tr is created.

After the second semiconductor layers 40a and 40b have been created, an insulation film 39 is formed. Then, a wiring layer to serve as the signal line Ld is created.

As shown in the figure, in the dummy pixel G-d′ of related art, the wiring layer to serve as the signal line Ld is electrically connected to the first semiconductor layer 35 through the contact section Ct.

After the wiring layer to serve as the signal line Ld has been created, an insulation film 41 also for flattening is formed. Then, after the insulation film 41 has been formed, a first light blocking layer 34 is created.

Subsequently, an insulation film 42 is formed on the first light blocking layer 34. Then, a transparent electrode 33 and an orientation film 43 are formed.

In addition, an opposite substrate 30, a transparent electrode 31 and an orientation film 44 are formed sequentially in the same order as enumerated in order to create a laminated stack. Then, between the laminated stack and the orientation film 43, a liquid crystal is sealed in order to create a liquid crystal layer 32. At that time, the process of sealing liquid crystal is carried out in such a way that the orientation film 44 included in the laminated stack is oriented to face the orientation film 43.

In this way, the dummy pixel G-d′ of related art is created.

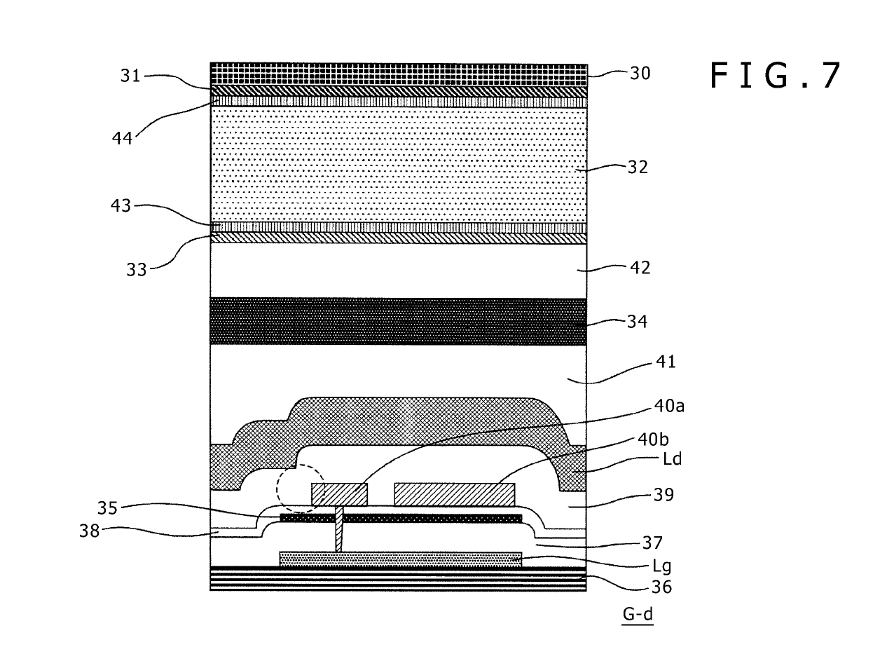

FIG. 7 is a diagram showing a more detailed cross-sectional structure of the dummy pixel G-d according to the first embodiment.

The dummy pixel G-d according to the first embodiment is different from the dummy pixel G-d′ of related art shown in FIG. 6 in that, in the case of the dummy pixel G-d according to the first embodiment, the contact section Ct for electrically connecting the first semiconductor layer 35 to the signal line Ld is eliminated.

It is to be noted that the contact section Ct can be eliminated from the dummy pixel G-d according to the first embodiment by adoption of a technique of changing the pattern of a mask used in the process of creating the contact section Ct.

As described above, in the dummy pixel G-d according to this embodiment, the contact section Ct is eliminated in order to electrically disconnect the pixel transistor Tr from the signal line Ld. By electrically disconnecting the pixel transistor Tr from the signal line Ld, variations of the V-T characteristic in the effective pixel area 1E-e can be effectively eliminated. As a result, it is possible to prevent the quality of the displayed image from deteriorating. As explained before, the variations of the V-T characteristic in the effective pixel area 1E-e are caused by performance deteriorations of the pixel transistor Tr caused by radiation of reflected light to the dummy pixel G-d.

In addition, in accordance with this embodiment, in the process of electrically disconnecting the pixel transistor Tr from the signal line Ld, the creation of the contact section Ct is merely omitted in order to electrically disconnect the pixel transistor Tr from the signal line Ld. That is to say, addition of special means and/or a new process is not required. In addition, it is not necessary to newly create a separate layer to serve as a light blocking layer at the same time.

In other words, in accordance with this embodiment, without raising problems such as decreased producibility and an increased cost which would be otherwise caused by a newly introduced additional process, it is possible to avoid image-quality deteriorations attributed to radiation of reflected light from the panel exit surface to the dummy pixel.

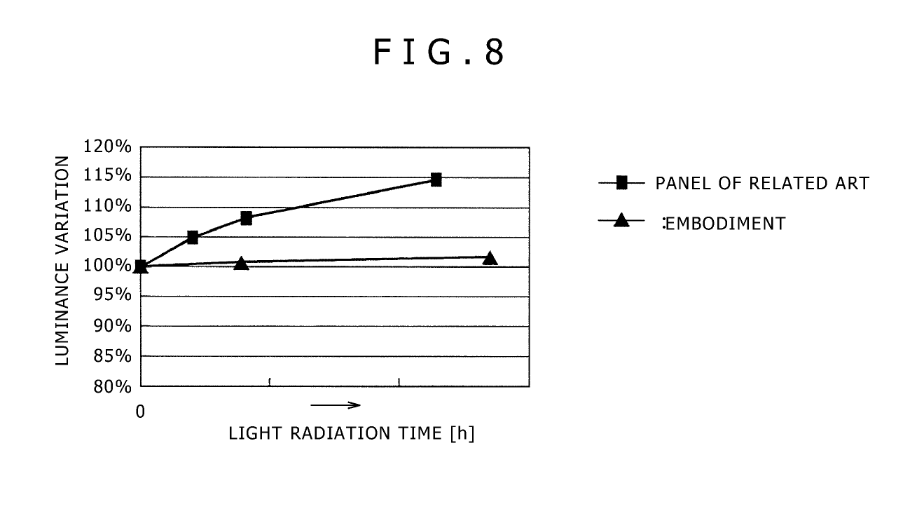

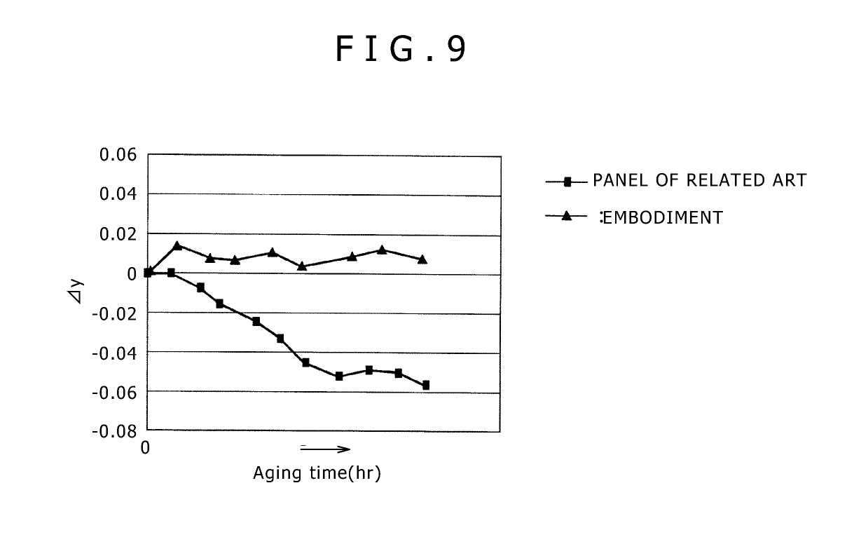

FIGS. 8 and 9 are diagrams for proving that the embodiment has a capability of avoiding deteriorations of the image quality.

To be more specific, FIG. 8 is a diagram showing experimental results representing relations between the time of light radiation to the pixel transistor Tr employed in the dummy pixel G-d and the variation of luminance of a pixel G in an effective pixel area 1E-e.

It is to be noted that a curve of black square marks represents the relation for the liquid crystal display panel of related art whereas a curve of black triangular marks represents the relation for the liquid crystal display panel according to the embodiment. The liquid crystal display panel of related art is a liquid crystal display panel employing the dummy pixel G-d′ of related art whereas the liquid crystal display panel according to the embodiment is a liquid crystal display panel employing the dummy pixel G-d according to the embodiment.

As shown in FIG. 8, in the case of the liquid crystal display panel of related art, the longer the time of light radiation to the pixel transistor Tr employed in the dummy pixel G-d′ of related art, the larger the variation of luminance of a pixel G in an effective pixel area 1E-e. That is to say, the curve for the liquid crystal display panel of related art shows a trend indicating that, as the time of light radiation becomes longer, the variation of the luminance gradually rises. It is thus obvious from these experiment results that the curve for the liquid crystal display panel of related art shows a trend indicating that, with the lapse of time, the quality of the displayed image deteriorates in accordance with the radiation of light to the pixel transistor Tr employed in the dummy pixel G-d′ of related art.

In the case of the liquid crystal display panel according to the embodiment, on the other hand, it is possible to verify the fact that the variation of luminance of a pixel G in an effective pixel area 1E-e remains all but the same without regard to the time of light radiation to the pixel transistor Tr employed in the dummy pixel G-d. It is thus obvious from these experiment results that image-quality deteriorations caused by the light radiation to the pixel transistor Tr employed in the dummy pixel G-d can be suppressed effectively.

FIG. 9 is a diagram showing experimental results representing relations between the aging time and the chromaticity change Ay of the displayed image. Also in this figure, a curve of black square marks represents the relation for the liquid crystal projector of related art whereas a curve of black triangular marks represents the relation for the liquid crystal projector according to the embodiment.

As shown in the figure, in the case of the liquid crystal projector of related art, the chromaticity change Ay of the displayed image decreases considerably with the aging time.

It is to be noted that the state of the chromaticity change Ay depends on the balance of the quantities of light incident to the liquid crystal display panels 1-R, 1-G and 1-B. The balance of the quantities of the incident light represents the degree at which the deterioration of what panel has a big effect on changes of the displayed image.

In the case of the liquid crystal projector 50 according to this embodiment, on the other hand, the chromaticity change Ay of the displayed image varies with the aging time in a range of ±0.02. That is to say, the variations of the chromaticity change Ay of the displayed image can be contained in a range not recognized by the visual sense of a human being. Thus, it is also obvious from these experiment results that, in accordance with this embodiment, the deteriorations of the quality of the displayed image can be suppressed effectively.

<4. Configuration of the Dummy Pixel According to a Second Embodiment>

In the case of the first embodiment, the creation of the contact section Ct in the dummy pixel G-d is omitted in order to electrically disconnect the pixel transistor Tr from the signal line Ld. In the case of a second embodiment, on the other hand, a portion of the first semiconductor layer 35 in which the pixel transistor Tr is created is cut off in order to electrically disconnect the pixel transistor Tr from the signal line Ld.

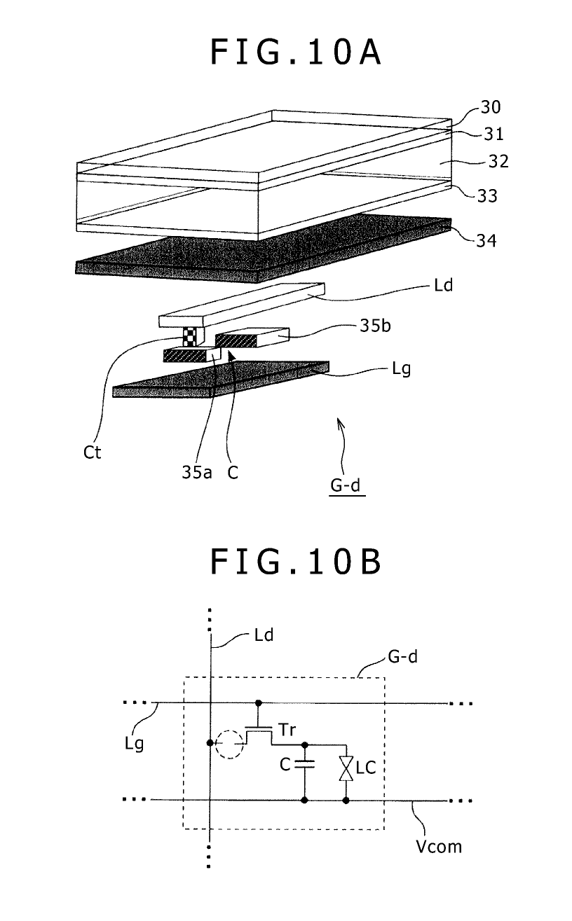

FIGS. 10A and 10B are explanatory diagrams referred to in the following description of the configuration of a dummy pixel G-d according to the second embodiment. To be more specific, FIG. 10A is a perspective diagram showing a simplified configuration of the dummy pixel G-d whereas FIG. 10B is a diagram showing the circuit of the dummy pixel G-d.

By comparing FIG. 10A with FIG. 5A, it becomes obvious that the dummy pixel G-d according to the second embodiment is different from the dummy pixel G-d according to the first embodiment in that, in the case of the dummy pixel G-d according to the second embodiment, a contact section Ct is provided as is the case with the dummy pixel G-d′ of related art whereas the first semiconductor layer 35 is divided into a first semiconductor layer 35a and a first semiconductor layer 35b as shown by a mark C in FIG. 10A. The first semiconductor layer 35a is a portion including a part connected to the contact section Ct whereas the first semiconductor layer 35b is a portion other than the first semiconductor layer 35a.

A dashed-line circle shown in the circuit diagram of FIG. 10B does not include a segment electrically connecting the source electrode of the pixel transistor Tr to the signal line Ld. That is to say, the dashed-line circle shows that the pixel transistor Tr is electrically disconnected from the signal line Ld.

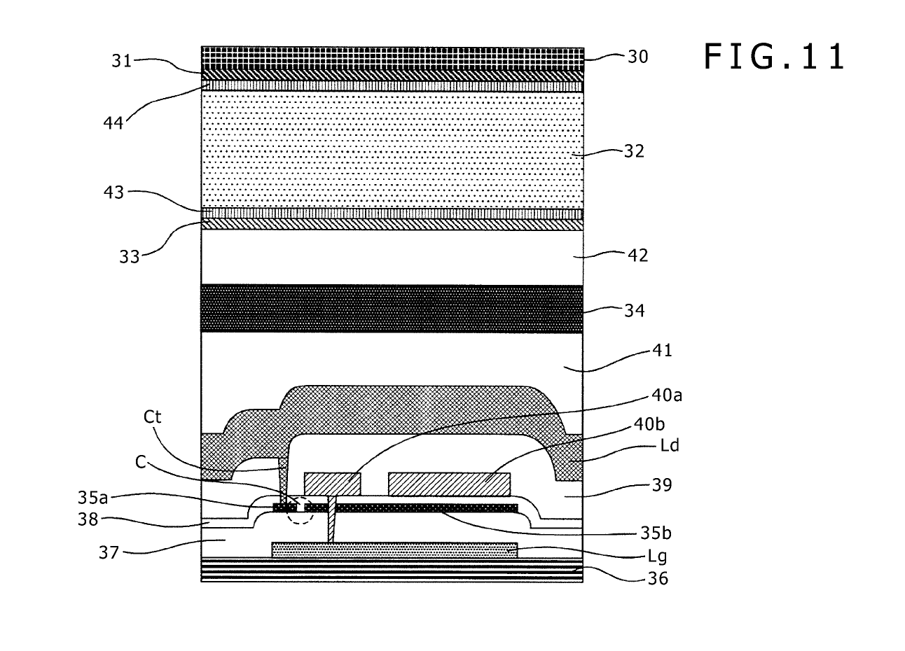

FIG. 11 is a diagram showing a more detailed cross-sectional structure of the dummy pixel G-d according to the second embodiment.

By comparing FIG. 11 with FIG. 7, it becomes obvious that the dummy pixel G-d according to the second embodiment is different from the dummy pixel G-d according to the first embodiment in that, in the case of the dummy pixel G-d according to the second embodiment, a contact section Ct is provided as is the case with the dummy pixel G-d′ of related art whereas the first semiconductor layer 35 is divided into the first semiconductor layer 35a and the first semiconductor layer 35b as shown by a mark C. The first semiconductor layer 35a is a portion including a part connected to the contact section Ct whereas the first semiconductor layer 35b is a portion other than the first semiconductor layer 35a.

In other words, the dummy pixel G-d according to the second embodiment is different from the dummy pixel G-d′ of related art shown in FIG. 6 only in that, in the case of the dummy pixel G-d according to the second embodiment, the first semiconductor layer 35 is divided into the first semiconductor layer 35a and the first semiconductor layer 35b.

Also in the configuration of the dummy pixel G-d according to the second embodiment described above, it is possible to electrically disconnect the pixel transistor Tr of the dummy pixel G-d from the signal line Ld. It is thus possible to demonstrate the effect of avoiding deteriorations of the quality of the displayed image in the same way as the first embodiment.

In addition, in the case of the second embodiment, it is necessary to merely divide the first semiconductor layer 35 into the first semiconductor layer 35a and the first semiconductor layer 35b. Thus, much like the first embodiment, it is possible to prevent the cost from rising due to addition of new processes and creation of other layers. That is to say, also in the case of the second embodiment, it is possible to avoid image-quality deteriorations attributed to radiation of reflected light from the panel exit surface to the dummy pixel without raising problems such as decreased producibility and an increased cost which would be otherwise caused by a newly introduced additional process.

<5. Typical Modifications>

A variety of embodiments of the present application have been described so far. However, implementations of the present application are by no means limited to the embodiments explained above.

For example, in accordance with the above explanation, in each dummy pixel G-d created in the dummy pixel area 1E-d, the pixel transistor Tr is electrically disconnected from the signal line Ld. In order to exhibit the effect of eliminating deteriorations of the quality of the image displayed on the effective pixel area 1E-e, the pixel transistor Tr is electrically disconnected from the signal line Ld not necessarily for each dummy pixel G-d created in the dummy pixel area 1E-d.

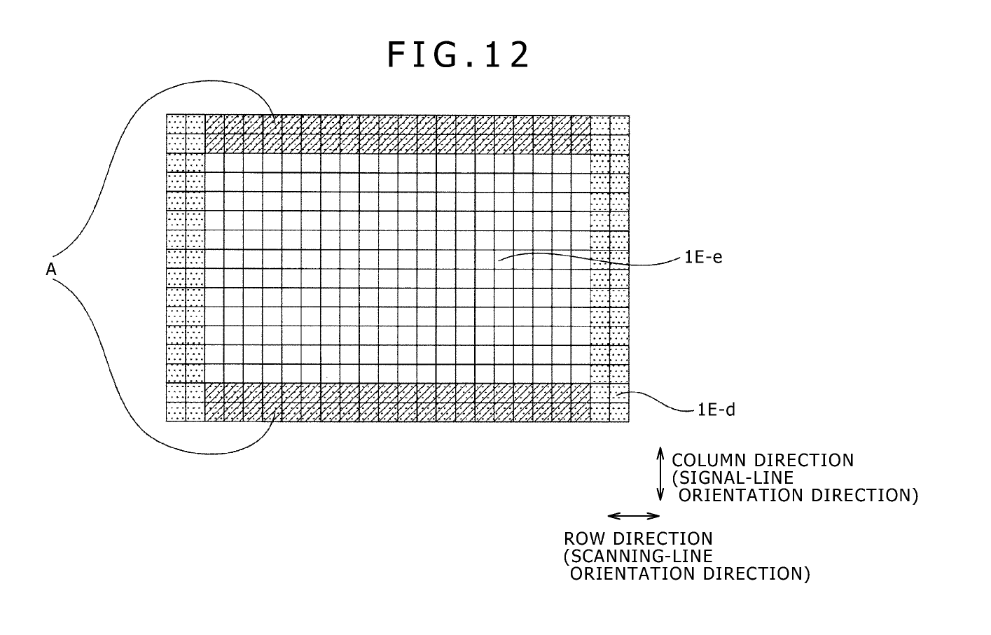

FIG. 12 is a diagram showing the top view of a pixel creation area 1E in the liquid crystal display panel 1. As shown in the figure, only in some specific dummy pixels G-d created in the dummy pixel area 1E-d, the pixel transistor Tr is electrically disconnected from the signal line Ld. The specific dummy pixels G-d are dummy pixels G-d created in hatched portions A shown in the figure. This is because it is obvious that the deteriorations of the pixel transistors Tr employed only in the specific dummy pixels G-d affect the pixels G created in the effective pixel area 1E-e through the signal lines Ld. That is to say, the pixel transistor Tr needs to be electrically disconnected from the signal line Ld for at least each specific dummy pixel G-d on the same column in the dummy pixel area 1E-d as the pixels G created in the effective pixel area 1E-e. In other words, the pixel transistor Tr needs to be electrically disconnected from the signal line Ld only for each specific dummy pixel G-d created in the dummy pixel area 1E-d as a dummy pixel sharing the signal line Ld with the pixels G created in the effective pixel area 1E-e.

In addition, in accordance with the description given so far, the present application is applied to a projection-type liquid crystal display device designed as a three-plate system. However, the present application can also be applied properly to a broad range of projectors each employing a liquid crystal display panel.

On top of that, cross-sectional structures of the pixel are by no means limited to those shown in FIGS. 7 and 11. That is to say, the cross-sectional structure of the pixel can be properly changed in accordance with the actual implementation of the liquid crystal display panel.

In addition, the present application can also be realized into the following implementations.

### (1) A Liquid Crystal Display Panel Wherein:

dummy pixels are created at locations surrounding an effective pixel area; and

if the dummy pixels include same-column dummy pixels provided on the same pixel column as pixels provided in the effective pixel area, at least, a pixel transistor employed in each of the same-column dummy pixels is electrically disconnected from a signal line.

(2) The liquid crystal display panel according to implementation (1), wherein a pixel transistor employed in each of the same-column dummy pixels is electrically disconnected from a signal line by eliminating a contact portion connecting the signal line to the pixel transistor.
(3) The liquid crystal display panel according to implementation (1) or (2), wherein a pixel transistor employed in each of the same-column dummy pixels is electrically disconnected from a signal line by separating a portion included in a semiconductor layer as a portion connected to the signal line from the semiconductor layer including the pixel transistor.
(4) The liquid crystal display panel according to any one of implementations (1) to (3), wherein a pixel transistor employed in each of the dummy pixels is electrically disconnected from a signal line.
(5) The liquid crystal display panel according to any one of implementations (1) to (4), wherein a first light blocking layer is created between the pixel transistor and a liquid crystal layer.
(6) The liquid crystal display panel according to any one of implementations (1) to (5), wherein a second light blocking layer is created at a position closer to a panel exit side than a layer in which the pixel transistor is created.
(7) A liquid crystal projector including:

a light source;

a liquid crystal display panel for carrying out optical modulation on light, which is emitted by the light source, in pixel units; and

a projection optical system for projecting light passing through the liquid crystal display panel, wherein

the liquid crystal display panel has dummy pixels created at locations surrounding an effective pixel, and

if the dummy pixels include same-column dummy pixels provided on the same pixel column as the effective pixel, a pixel transistor employed in each of the same-column dummy pixels is electrically disconnected from a signal line.

(8) The liquid crystal projector according to implementation (7), wherein a polarization plate is provided on the light incidence side of the liquid crystal display panel whereas another polarization plate is provided on the light exit side of the liquid crystal display panel.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A liquid crystal display panel wherein:
dummy pixels are created at locations surrounding an effective pixel area; and
if said dummy pixels include same-column dummy pixels provided on the same pixel column as pixels provided in said effective pixel area, at least, a pixel transistor employed in each of said same-column dummy pixels is electrically disconnected from a signal line.

2. The liquid crystal display panel according to claim 1, wherein a pixel transistor employed in each of said same-column dummy pixels is electrically disconnected from a signal line by eliminating a contact portion connecting said signal line to said pixel transistor.

3. The liquid crystal display panel according to claim 1, wherein a pixel transistor employed in each of said same-column dummy pixels is electrically disconnected from a signal line by separating a portion included in a semiconductor layer as a portion connected to said signal line from said semiconductor layer including said pixel transistor.

4. The liquid crystal display panel according to claim 1, wherein a pixel transistor employed in each of said dummy pixels is electrically disconnected from a signal line.

5. The liquid crystal display panel according to claim 1, wherein a first light blocking layer is created between said pixel transistor and a liquid crystal layer.

6. The liquid crystal display panel according to claim 1, wherein a second light blocking layer is created at a position closer to a panel exit side than a layer in which said pixel transistor is created.

7. A liquid crystal projector comprising:
a light source;
a liquid crystal display panel for carrying out optical modulation on light, which is emitted by said light source, in pixel units; and
a projection optical system for projecting light passing through said liquid crystal display panel, wherein
said liquid crystal display panel has dummy pixels created at locations surrounding an effective pixel, and
if said dummy pixels include same-column dummy pixels provided on the same pixel column as said effective pixel, a pixel transistor employed in each of said same-column dummy pixels is electrically disconnected from a signal line.

8. The liquid crystal projector according to claim 7, wherein a polarization plate is provided on the light incidence side of said liquid crystal display panel whereas another polarization plate is provided on the light exit side of said liquid crystal display panel.
